(19) United States
(12) Patent Application Publication
(10) Pub. No.: US 2024/0375285 A1
(43) Pub. Date: Nov. 14, 2024

(54) ROBOTIC PROCESS AUTOMATION

(71) Applicant: SJ Computers, LLC, Eagan, MN (US)

(72) Inventors: Talha HAMZA, Farmington, MN (US); Ijaz HAIDAR, Eagan, MN (US)

(73) Assignee: SJ Computers, LLC, Eagan, MN (US)

(21) Appl. No.: 18/316,398

(22) Filed: May 12, 2023

(51) Int. Cl. B25J 9/16

(52) U.S. Cl. CPC B25J 9/1697

(57) ABSTRACT

A robotic process automation compares an incoming digital video feed with a dictionary of saved images. A host computer may process the digital video output of a target computer, for example, using a video capture card. An incoming video frame as received from the target computer may be matched, by the host computer, to an image stored in the host computer's dictionary. Average hashes of the incoming frame and the image in the dictionary may be calculated. If the difference between the two hashes falls within a predefined range set by the user, a keystroke may be sent.

### FIELD

An exemplary embodiment relates to the field of automation.

### BACKGROUND

Automation provides major advantages to several fields of computing. Software may be able to programmatically execute instructions and perform operations that would otherwise require manual input from a user. Thus, large amounts of time can be saved via the use of automation. Tasks can be executed and greatly simplified by automating repetitive steps. Complex searches can also be automated based on key words or symbols.

Typical automation programs interact with the computing environment using machine language to instruct the operating system of a device to perform certain operations. This often requires extensive knowledge of a specialized programming language so that the automation can properly interact with the operating system and files or data therein. The input needs to be properly accessed and parsed using the proper syntax. Certain scripts and macros may interact or control elements of a graphical user interface, sometimes based on the location of the elements. However, automations such as these still need to be implemented on the same operating system as the targeted device, and may be prone to errors based on changes to the user interface, for example, due to an update.

### SUMMARY

According to at least one exemplary embodiment, a method and system for automating processes of a target system may be shown and described. An exemplary embodiment may automate tasks or operations on a target machine from a host. Software does not need to be installed on the target computer, and thus an exemplary embodiment does not require the use of firmware, embedded systems, internet connectivity, or even the operating system of the target computer. For example, an embodiment may thus be capable of tasks such as updating or configuring the BIOS settings of a computer, or other process outside of the operating system. Further, since an exemplary embodiment does not directly interact with the target system, data on the target system remains protected and is not compromised.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a schematic illustrating the connection between target and host systems.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

An exemplary embodiment may include a host computer implementing a robotic process automation software. The host computer may be, for example, a computer processor with a memory and which is capable of receiving input from a target computer. The target computer may also be any computing device with a processor and memory which is capable of sending an output to an external device.

In an exemplary embodiment, the host and target devices may be connected via USB. For example, the HDMI output of the target device is connected to the input port of a video capture card. The video signal is processed and encoded into a digital format that can be transferred over the USB connection to the host device. The host device may receive the captured data stream in the form of video or a series of images captured by the video capture card on the target computer.

Each incoming video frame or image may be compared, on the host computer, to images in a database stored on or accessible by the host. Averages hashes of the incoming frame and an image in the database may be calculated. If the difference between the hashes falls within a predefined range, a keystroke or set of keystrokes may be sent. The predefined range may be based on user input. The name of the keystroke may be saved as the image's name, and once a match is found, the specific keystroke associated with the matched image may be executed.

The database may be configured such that the images stored therein are ordered according to the steps that the host mimics. For example, a first step in a process may be a first stored image in the database or in a subset of the database. The second step may then be the second image, and so on. This can greatly reduce the computational complexity of the comparisons required for an automation to be executed based on the incoming video feed, by directing the host computer to first search the second or next image after completing a first or preceding step. Images may also be compared using optimal mass transport, graph theory, and Wasserstein metric for example. A perceptual and/or average hash can be used to quickly compare stored images with the live video frame. For example, a hash may be calculated for each incoming frame or image, and then may be compared to hashes in the database associated with stored images.

An exemplary embodiment may provide several advantages. For example, an embodiment may allow for secure or air-gapped systems which cannot be remotely accessed to utilize automations. For example, BIOS configuration setup typically takes place before an operating system of a computer is loaded into working memory or processed, and thus typically lacks internet or operating system connectivity. However, an exemplary host can receive a video feed or set of images/frames from a target device which simply outputs its own video feed and thus does not require any software or connectivity on the target beyond video output. An automation can therefore be applied to any system which outputs video.

It may be contemplated that the video stream is the only input to the host system and the only output of the target system. No software needs to be installed, maintained, or configured on the target system, and system hardware or software requirements of the target system are irrelevant. Since the only interaction between the target and host systems is via the video feed, potential malware or viruses on the target system cannot be transmitted to the host system and vice versa. The host does not directly communicate with the target, and so data does not travel between the two systems beyond the video feed and the simulated keystrokes. In addition, an exemplary embodiment ensures compliance with industry data policies, such as compliance requirements that govern the storage and processing of data.

The target system may also be configured to receive input. For example, mouse clicks, keystrokes, touch-events, or other inputs may be sent from the host to the target system in order to allow the host to interact with the target system or to automate a task or setting on the target. In an exemplary embodiment, the host may send commands to the target device via, for example, an Arduino or other intermediary device. The intermediary device may convert output from the host device, in the form of keystrokes, into recognizable inputs, such as keystrokes, into the target system. To send keystrokes, two intermediary boards may be programmed to communicate with one another in a Master Writer/Slave Receiver configuration via, for example, the I2C synchronous serial protocol. When the host matches an incoming video frame to an image in the dictionary, the host may write the ASCII value of the keystrokes associated with the matched image to an open serial port. The Master Writer board may be connected to the serial port via, for example, a USB connection. The Master Writer board may be programmed to continuously read input from the serial port to the I2C bus which may thus be sent to the Slave Receiver board. The Slave board may be programmed to map the incoming ASCII values received from the I2C bus of the Master to the corresponding keyboard key press or presses. The mapped key presses may then be sent to the target computer, for example, via a USB connection.

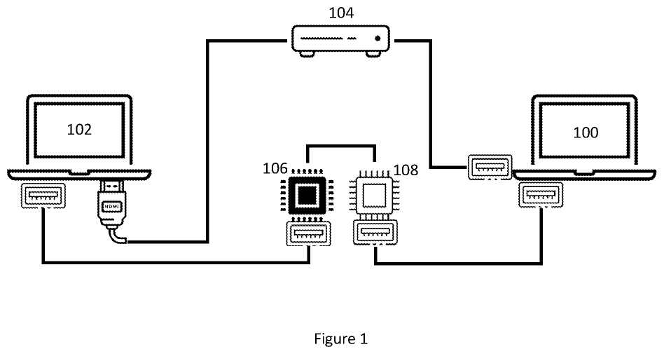

FIG. 1 may illustrate the connections between a target and host in an exemplary embodiment. A target computer 102 may have USB and video connectivity. In the exemplary embodiment shown in FIG. 1, the video connectivity is via an HDMI port. A video capture device 104 may connect to the video or HDMI port of the target computer 102 as well as a USB or other input port of the host computer 100. Further, an input port of the target device 102 may be connected to a first, slave intermediary device 106. The slave intermediary device may connect with a master intermediary device 108. The master intermediary device 108 may be connected to an output port, such as a USB port, of the host computer 100. Outputs from the output port of the host computer 100 may include, for example, the keystrokes and inputs related to the automation implemented on the target computer.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for automating a process on a target device, comprising:
a video capture device connected to a video output port of the target device;
a host computing device configured to receive an output of the video capture device and compare the received output to images within a stored database of images;
a first intermediary board configured to convert an ASCII output from the host computing device into one or more computer-readable inputs;
a second intermediary board configured to transmit the computer-readable inputs from the first intermediary board to the target device.

2. The system of claim 1, wherein the computer-readable inputs comprise keystrokes.

3. The system of claim 1, wherein the output of the video capture device comprises a series of images.

4. A method for automating a process on a target device, comprising:
transmitting a video or image output from the target device to a host device;
comparing, on the host device, the received video or image output to a plurality of images from a database stored on or accessible by the host device;
upon identifying a matched image from the plurality of images which matches the received video or image output, sending, from the host device, one or more commands from the host device to an intermediary board;
converting the commands received from the host device into a computer-readable input on the intermediary board; and
sending the computer-readable input from the intermediary board to the target computer.

5. The method of claim 4, wherein the computer-readable input comprises one or more keystrokes.

6. The method of claim 4, wherein the commands comprise an ASCII input.

7. The method of claim 4, wherein each image from the plurality of images in the database comprises one or more associated commands, wherein the command sent from the host device is chosen based on the commands associated with the matched image.
